(19) United States
(12) Patent Application Publication
(10) Pub. No.: US 2015/0314386 A1
(43) Pub. Date: Nov. 5, 2015

(54) ADAPTOR FOR A TOOL OR HANDLE

(71) Applicant: GM GLOBAL TECHNOLOGY OPERATIONS LLC, Detroit, MI (US)

(72) Inventors: Randall L. Miller, Franklin, TN (US); Donald K. Rutherford, Franklin, TN (US); Stephen M. Holland, Murfreesboro, TN (US)

(73) Assignee: GM GLOBAL TECHNOLOGY OPERATIONS LLC, Detroit, MI (US)

(21) Appl. No.: 14/269,638

(22) Filed: May 5, 2014

(51) Int. Cl. B23K 3/08; F16B 2/06

(52) U.S. Cl. CPC B23K 3/087; F16B 2/06

(57) ABSTRACT

An adaptor can adjustably couple a tool to a mount and includes a clamping assembly, a coupling assembly, and a cam lock assembly. The clamping assembly includes a base and a clamp movably coupled to the base. The base and the clamp together define a substantially circular pocket. The coupling assembly includes a ball sized to be disposed in the substantially circular pocket and a shank extending from the ball. The cam lock assembly includes a camming base and includes a lever pivotally coupled to the camming base. The lever can pivot relative to the camming base between an unlocked position and a locked position. The cam lock assembly further includes a retention fastener and a draw fastener. Moving the lever toward the locked position causes the clamp to press the ball against the base, thereby locking the position of the ball relative to the clamping assembly.

### TECHNICAL FIELD

The present disclosure relates to an adaptor for adjusting the position of a handle or tool with respect to a mount.

### BACKGROUND

During manufacturing processes, tools are typically used to perform work on a workpiece. For example, a welding tool can be used to join two parts together. Operators sometimes manually manipulate these tools and may need to adjust the position and orientation of these tools.

### SUMMARY

It is therefore useful to develop an adaptor capable of coupling a tool to a mount while allowing the operator to adjust the position and orientation of the tool with respect to the mount. In an embodiment, the adaptor includes a clamping assembly, a coupling assembly, and a cam lock assembly. The clamping assembly includes a base and a clamp movably coupled to the base. The base and the clamp together define a substantially circular pocket. The coupling assembly includes a ball sized to be disposed in the substantially circular pocket and a shank extending from the ball. The cam lock assembly includes a camming base coupled to the clamp. The cam lock assembly further includes a lever pivotally coupled to the camming base. Accordingly, the lever can pivot relative to the camming base between an unlocked position and a locked position. The cam lock assembly further includes a retention fastener and a draw fastener extending through the clamp and the base. The draw fastener interconnects the retention fastener and the lever. During operation of the adaptor, moving the lever from the unlocked position toward the locked position causes the retention fastener to move toward the base and the clamp to press the ball against the base, thereby locking the position and orientation of the ball relative to the clamping assembly.

The present disclosure also includes a tool arrangement including the adaptor described above and a tool coupled to the adaptor. In addition, the tool arrangement includes a mount coupled to the adaptor.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, side view of an adaptor;

FIG. 2 is a schematic, front view of the adaptor in FIG. 1; and

FIG. 3 is a schematic, top view of the tool arrangement including the adaptor shown in FIG. 1 and a tool coupled to the adaptor.

### DETAILED DESCRIPTION

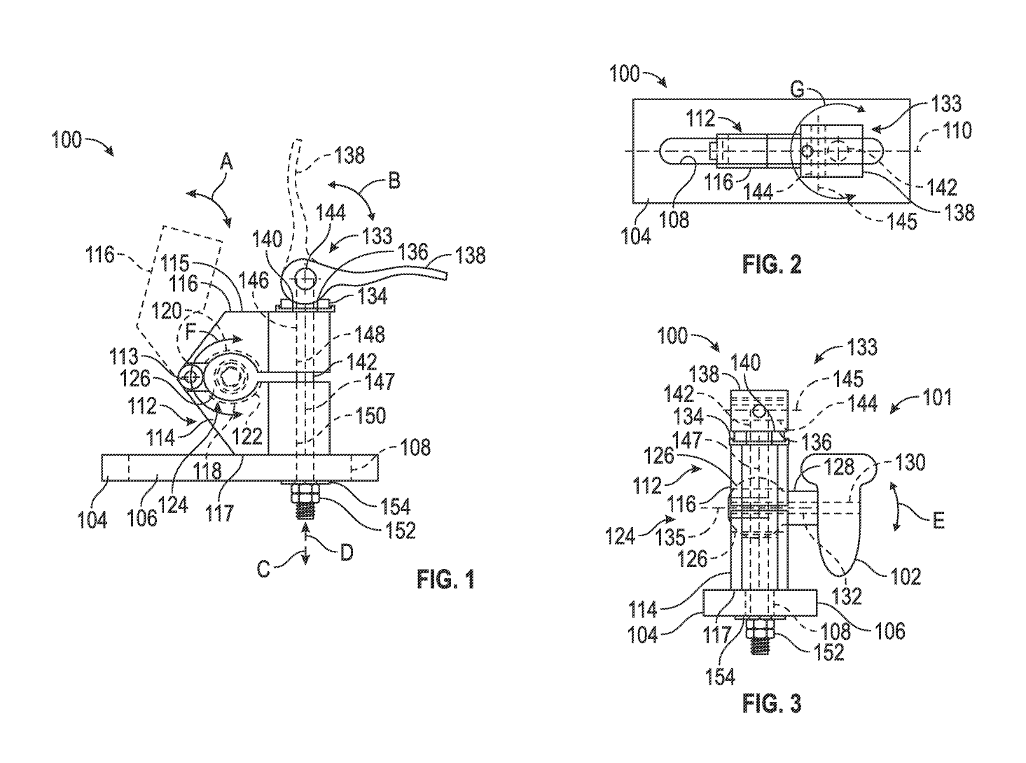

Referring to the drawings, wherein like reference numbers refer to like components throughout the several figures, FIGS. 1-3 schematically illustrate adaptor 100 for adjusting the position and orientation of a tool 102 or a tool handle relative to a workpiece. In the present disclosure, the term “tool” includes a handle. The tool 102 may be a welding tool or a handle and is a part of the tool arrangement 101. The adaptor 100 is also part of the tool arrangement 101 and additionally includes a mount 104. The mount may be a substantially planar plate and therefore capable of being placed on a table. Further, the mount 104 includes a mount body 106 and a slot 108 extending axially along a first axis 110.

With reference to FIGS. 1-3, the adaptor 100 includes a clamping assembly 112 having a base 114 and a clamp 116 movably coupled to the base 114. Accordingly, the clamp 116 can move relative to the base 114 between a first clamp position (in dashed lines) and a second clamp position (in solid lines). The base 114 and clamp 116 together define a substantially circular pocket 118 when the clamp 116 is in the second clamp position. The clamp 116 defines a first substantially semi-circular surface 120, and the base 114 defines a second substantially semi-circular surface 122. The first and second substantially semi-circular surfaces 120, 122 together define the substantially circular pocket 118. The clamp 116 additionally defines a first substantially planar surface 115 (FIG. 1), and the base 114 defines a second substantially planar surface 117 (FIG. 1). The second substantially planar surface 117 is directly mounted on the mount 104.

The clamping assembly 112 further includes a hinge pin 113 pivotally interconnecting the clamp 116 and the base 114. Accordingly, the clamp 116 can pivot relative to the base 114 about the hinge pin 113 in the direction indicated by arrows A. Specifically, the clamp 116 can pivot relative to the base 114 between the first clamp position (in dashed lines) and the second clamp position (in solid lines).

The adaptor 100 additionally includes a ball 126 configured, shaped, and sized to be received in the substantially circular pocket 118. The ball 126 is part of a coupling assembly 124 and is substantially spherical. The substantially spherical shape of the ball 126 allows the ball 126 to rotate within the substantially circular pocket 118. The coupling assembly 124 further includes a shank 128 extending from the ball 126. The shank 128 can be directly coupled to the tool 102. To this end, the coupling assembly 124 includes a coupling fastener 130, such as a screw, extending through the ball 126, the shank 128, and the tool 102, thereby connecting the coupling assembly 124 to the tool 102. The coupling fastener 130 therefore interconnects the ball 126, the shank 128 and the tool 102. The coupling assembly 124 defines a coupling opening 132 configured, shaped, and sized to receive the coupling fastener 130. The coupling opening 132 extends through the ball 126 and the shank 128 along a coupling axis 135 and can accommodate the coupling fastener 130. The coupling fastener 130 can also extend through (or at least into) the tool 102 in order to couple the coupling assembly 124 to the tool 102. The ball 126 and the shank 128 can rotate about the coupling axis 135.

Aside from the coupling assembly 124, the adaptor 100 includes a cam lock assembly 133 for locking the position and orientation of the ball 126 in the substantially circular pocket 118. The cam lock assembly 133 includes a camming base 134 coupled to the clamp 116. In particular, the camming base 134 is fixed to the clamp 116 such the camming base 134 moves in unision with the clamp 116. As a non-limiting example, the camming base 134 is directly mounted on the first substantially planar surface 115. In the depicted embodiment, the camming base 134 defines a first camming surface 136, which is concave.

The cam lock assembly 133 also includes a lever 138 movable relative to the camming base 134 between an unlocked position (shown in dashed lines) and a locked position (shown in solid lines). The lever 138 defines a second camming surface 140 mating with the first camming surface 136 As a consequence, the second camming surface 140 slides along the first camming surface 136 as the lever 138 moves relative to the camming base 134 between the unlocked and locked positions.

The cam lock assembly 133 further includes draw fastener 142 and a pivot pin 144 interconnecting the lever 138 and the draw fastener 142. The pivot pin 144 extends along a second axis 145, which is substantially perpendicular to the first axis 110. Accordingly, the lever 138 can pivot relative to the camming base 134 about the pivot pin 144 in the directions indicated by double arrows B. The draw fastener 142 is directly coupled to the pivot pin 144 and extends through the clamp 116, the base 114, and the mount 104 along a third axis 147 in order to couple the lever 138 to the clamping assembly 112 and the mount 104. As a result, moving the lever 138 relative to the camming base 134 toward the unlocked position causes the draw fastener 142 to move linearly toward the direction indicated by arrow C. Conversely, moving the lever 138 relative to the camming base 134 toward the locked position causes the draw fastener 142 to move linearly in the direction indicated by arrow D. In the depicted embodiment, the draw fastener 142 is a screw. It is nonetheless envisioned that the draw fastener 142 may be some other kind of fastener.

The camming base 134 defines a camming base opening 146 configured, shaped, and sized to partially receive the draw fastener 142. The camming base opening 146 extends along the third axis 147. The clamp 116 defines a clamp opening 148 configured, shaped, and sized to partially receive the draw fastener 142. The clamp opening 148 extends along the third axis 147 at least when the clamp 116 is in the second clamp position. The clamp opening 148 partially receives the draw fastener 142. In other words, the draw fastener 142 is partially disposed in the clamp opening 148. The base 114 defines a base opening 150 configured, shaped, and sized to partially receive the draw fastener 142. The base opening 150 extends along the third axis 147 and partially receives the draw fastener 142. In other words, the draw fastener 142 is partially disposed in the base opening 150. The slot 108 also partially receives the draw fastener 142.

The cam lock assembly 133 additionally includes at least one retention fastener 152, such as a nut, coupled to the draw fastener 142. In the depicted embodiment, the cam lock assembly 133 includes two retention fasteners 152 (e.g., nuts) mating with the draw fastener 142 (e.g., screw). The cam lock assembly 133 also includes a washer 154 disposed between the mount 104 and the retention fasteners 152.

In operation, the adaptor 100 can be used to adjust the position and orientation of the tool 102 relative to the mount 104 in accordance with the ergonomic preferences of the tool operator. The engagement between the substantially spherical ball 126 and the substantially circular pocket 118 allows the ball 126 to rotate in multiple directions within the substantially circular pocket 118 when the clamp 116 is in the second clamp position and the lever 138 is in the unlocked position. Because the coupling assembly 124 is coupled to the tool 102, rotating the ball 126 within the substantially circular pocket 118 causes the tool 102 to move relative to the mount 104. Thus, the ball 126 can be moved within the substantially circular pocket 118 in order to adjust the orientation of the tool 102 relative to the mount 104 in the directions indicated by double arrows E (FIG. 3). Specifically, the orientation of the tool 102 can be adjusted about sixty (60) degrees with respect to the mount 104 in the directions indicated by double arrows E (FIG. 3) when the clamp 116 is in the second clamp position and the lever 138 is in the unlocked position. In addition, the ball 126 can be rotated within the pocket 118 in the directions indicated by double arrows F in order to adjust the position and orientation of the tool 102 with respect to the mount 104. Specifically, the ball 126 can be rotated three hundred sixty (360) degrees within the substantially circular pocket 118 in the directions indicated by double arrows F when the clamp 116 is in the second clamp position and the lever 138 is in the locked position.

The clamping assembly 112 and the cam lock assembly 133 can rotate relative to the mount 104 about the draw fastener 142 when the lever 138 is in the unlocked position. In other words, the clamping assembly 112 and the cam lock assembly 133 can rotate relative to the mount 104 about the third axis 147 when the lever 138 is in the unlocked position. In the depicted embodiment, the clamping assembly 112 and the cam lock assembly 133 can rotate thee hundred sixty (360) degrees relative to the mount 104 in the directions indicated by double arrows G. Because the coupling assembly 124 interconnects the clamping assembly 112 and the tool 102, rotating the clamping assembly 112 about the draw fastener 142 causes the tool 102 to rotate relative to the mount 104 in the directions indicted by double arrows G when the lever 138 is in the unlocked position.

When the lever 138 is in the unlocked position, the coupling assembly 124 and the clamping assembly 112 can move with respect to the mount 104 along the first axis 110. In particular, because the draw fastener 142 is partially disposed in the slot 108, the slot 108 can serve as a guide for the movement of the clamping assembly 112 and the coupling assembly 124 along the first axis 110 when the lever 138 is in the unlocked position (dashed lines). Accordingly, the tool 102 can be adjusted in the desired position in accordance with the ergonomic preferences of the tool operator when the lever 138 is in the unlocked position (dashed lines).

After adjusting the position and orientation of the tool 102 with respect to the mount 104, the tool 102 can be locked in position using the cam lock assembly 133. To do so, the lever 138 is pivoted about the pivot pin 144 from the unlocked position (dashed lines) to the locked position (solid lines). The draw fastener 142 (e.g., screw) interconnects the retention fastener 152 (e.g., nut) and the lever 138 such that moving the lever 138 from the unlocked position toward the locked position causes the draw fastener 142 to move in the direction indicated by arrow D, thereby causing the retention fastener 152 to move toward the base 114 in the direction indicated by arrow D. In other words, moving the lever 138 from the unlocked position toward the locked position causes the retention fastener 152 to move toward the base 114 in the direction indicated by arrow D. Consequently, the retention fastener 152 exerts pressure on the mount 104 in the direction indicated by arrow D. The pressure exerted by the retention fastener 152 on the mount 104 also causes the clamping assembly 112 and the coupling assembly 124 to be locked relative to the mount 104. Specifically, the pressure exerted by the retention fastener 152 on the mount 104 also causes the cam lock assembly 133 to exert a downward force on the clamp 116. As a result, the clamp 116 presses the ball 126 against the base 114 and, therefore, the ball 126 is clamped between the base 114 and the clamp 116. When the ball 126 is clamped in the pocket 118 between the base 114 and the clamp 116, the position and orientation of the ball 126 is fixed in place with respect to the mount 104. As discussed above, the coupling assembly 124 interconnects the clamping assembly 112 and the tool 102. Consequently, moving the lever 138 from the unlocked position (dashed lines) to the locked position (solid lines) locks the position and orientation of the ball 126 and the tool 102 relative to the clamping assembly 112 and the mount 104.

While the best modes for carrying out the invention have been described in detail, those familiar with the art to which this invention relates will recognize various alternative designs and embodiments for practicing the invention within the scope of the appended claims.

1. An adaptor, comprising:
a clamping assembly including a base and a clamp movably coupled to the base, wherein the base and the clamp together define a substantially circular pocket;
a coupling assembly includes a ball sized to be disposed in the substantially circular pocket and a shank extending from the ball;
a cam lock assembly including:
a camming base coupled to the clamp; and
a lever pivotally coupled to the camming base such that the lever is pivotable relative to the camming base between an unlocked position and a locked position;
a retention fastener; and
a draw fastener extending through the clamp and the base; and
wherein the draw fastener interconnects the retention fastener and the lever such that moving the lever from the unlocked position toward the locked position causes the retention fastener to move toward the base and the clamp to press the ball against the base, thereby locking a position and an orientation of the ball relative to the clamping assembly.

2. The adaptor of claim 1, wherein the clamp is movable relative to the base between a first clamp position and a second clamp position, and the clamp and the base together define the substantially circular pocket when the clamp is in the second clamp position.

3. The adaptor of claim 1, wherein the camming base defines a first camming surface, and the lever defines a second camming surface mating with the first camming surface such that the second camming surface slides along the first camming surface as the lever moves between the unlocked and locked positions.

4. The adaptor of claim 3, wherein the first camming surface is convex.

5. The adaptor of claim 4, wherein the second camming surface is concave.

6. The adaptor of claim 2, wherein the ball is substantially spherical and is sized to be received in the substantially circular pocket such that the ball is rotatable relative to the clamping assembly when the lever is in the unlocked position and the clamping assembly is in the second clamp position.

7. The adaptor of claim 1, wherein the base defines a base opening, and the draw fastener is partially disposed in the base opening.

8. The adaptor of claim 1, wherein the clamp defines a clamp opening, and the draw fastener is partially disposed in the clamp opening.

9. The adaptor of claim 1, wherein the clamp defines a first semi-circular surface partially defining the substantially circular pocket.

10. The adaptor of claim 1, wherein the base defines a second semi-circular surface partially defining the substantially circular pocket.

11. The adaptor of claim 1, wherein the retention fastener is a nut, and the draw fastener is a screw coupled to the nut.

12. The adaptor of claim 1, wherein the clamp is pivotally coupled to the base.

13. A tool arrangement, comprising:
a mount;
a clamping assembly disposed on the mount, the clamping assembly including a base and a clamp movably coupled to the base, wherein the base and the clamp together define a substantially circular pocket;
a tool;
a coupling assembly includes a ball sized to be disposed in the substantially circular pocket and a shank extending from the ball, wherein the shank is coupled to the tool;
a cam lock assembly including:
a camming base coupled to the clamp; and
a lever pivotally coupled to the camming base such that the lever is pivotable relative to the camming base between an unlocked position and a locked position;
a retention fastener; and
a draw fastener extending through the clamp and the base; and
wherein the draw fastener interconnects the retention fastener and the lever such that moving the lever from the unlocked position toward the locked position causes the clamp to press the ball against the base, thereby locking a position and an orientation of the tool relative to the mount.

14. The tool arrangement of claim 13, wherein the ball is substantially spherical and is sized to be received in the substantially circular pocket such that the ball is rotatable relative to the clamping assembly when the lever is in the unlocked position and the clamping assembly is in the second clamp position.

15. The tool arrangement of claim 13, wherein the camming base defines a first camming surface, and the lever defines a second camming surface mating with the first camming surface such that the second camming surface slides along the first camming surface as the lever moves between the unlocked and locked positions.

16. The tool arrangement of claim 15, wherein the first camming surface is convex.

17. The tool arrangement of claim 16, wherein the second camming surface is concave.

18. The tool arrangement of claim 13, wherein the clamp defines a first semi-circular surface partially defining the substantially circular pocket.

19. The tool arrangement of claim 13, wherein the base defines a second semi-circular surface partially defining the substantially circular pocket.

20. The tool arrangement of claim 13, wherein the mount defines a slot, and the draw fastener is partially disposed in the slot.
